(19) United States
(12) Patent Application Publication
(10) Pub. No.: US 2015/0020639 A1
(43) Pub. Date: Jan. 22, 2015

(54) STEERING SHAFT FOR A MOTOR VEHICLE

(71) Applicant: THYSSENKRUPP PRESTA AKTIENGESELLSCHAFT, Eschen (LI)

(72) Inventors: Andreas Kornmayer, Ravensburg (DE); Karl-Mathias Hehle, Hoerbranz (AT)

(21) Appl. No.: 14/379,885

(22) PCT Filed: Feb. 13, 2013
(86) PCT No.: PCT/EP2013/000411

§ 371 Date: Aug. 20, 2014

(30) Foreign Application Priority Data
Feb. 21, 2012 (DE) 10 2012 101 388.8

(51) Int. Cl. B62D 1/18

(52) U.S. Cl. CPC B62D 1/18
USPC 74/493

(57) ABSTRACT

A steering column for a motor vehicle, with a steering shaft comprising a rearward steering shaft segment that is rotatable about a longitudinal center axis and on which a steering wheel is mountable on a rearward end, and at least one further steering shaft segment connected with the rearward steering shaft segment via a universal joint. The universal joint comprises a rearward joint fork, a front joint fork and a universal joint cross connecting the rearward joint fork and the front joint fork. For damping vibrations transmitted via the steering shaft a damping element is provided which comprises an inner damper part having an outer circumferential contour deviating from the ideal circular form, an outer damper part encompassing the inner damper part having an inner circumferential contour deviating from the circular form, and an elastomeric damping material disposed between the inner damper part and the outer damper part.

The invention relates to a steering column for a motor vehicle, with a steering shaft comprising a rearward steering shaft segment that extends in a straight line and is rotatable about a longitudinal center axis and on which a steering wheel is mountable on a rearward end, and at least one further steering shaft segment connected with the rearward steering shaft segment via a universal joint, which joint comprises a rearward joint fork, a front joint fork and a universal joint cross connecting the rearward joint fork and the front joint fork, wherein for damping vibrations transmitted via the steering shaft a damping element is provided which comprises an inner damper part having, viewed in cross section through the damping element, an outer circumferential contour deviating from the ideal circular form, an outer damper part encompassing the inner damper part having, viewed in cross section through the damping element, an inner circumferential contour deviating from the circular form, and an elastomeric damping material disposed between the inner damper part and the outer damper part.

Steering shafts of motor vehicles serve for transmitting the rotary motion from a steering wheel to a steering gearing. Such steering shafts conventionally comprise several straight segments each connected via a universal joint, wherein a rearward (with reference to the forward driving direction) steering shaft segment adjoins the steering wheel and is rotatably bearing supported by a jacket unit. In order to enable, in the event of a crash, the rearward steering shaft segment to be pushed together, this segment comprises two subpieces that are telescopable with respect to one another. Via a first universal joint of the steering shaft the rearward steering shaft segment adjoins a middle steering shaft segment which, again via a universal joint, is adjoined by a front steering shaft segment connected to the steering gearing. The middle and/or front steering shaft segments can also be telescopable. The middle steering shaft segment can also be omitted such that the first universal joint is directly adjoined by the front steering shaft segment. The steering shaft, together with the parts bearing and supporting this steering shaft, which are connected with the body of the motor vehicle, is conventionally referred to as a steering column. To permit adaptation to the seating position of the driver, such steering columns are frequently implemented such that they are adjustable, wherein the adjustability can include the adjustment in length (by shifting the rearward end of the rearward steering shaft segment in the direction of the longitudinal center axis of the rearward steering shaft segment) and/or the adjustment in height or inclination (by swiveling the rearward steering shaft segment about a horizontal axis at right angles to the longitudinal center axis of the rearward steering shaft segment).

To dampen the vibrations transmitted via the steering shaft, damping elements are known. For example EP 1 45 572 A1 discloses a damping element disposed in the front steering shaft segment. This element comprises an inner and an outer damper part between which an elastomeric damping material is disposed, wherein each damper part is formed by an end segment of a subpiece of the front steering shaft segment and has a cross section contour deviating from the circular form in order to develop a form closure with respect to a rotary motion.

EP 1 260 725 A2 and JP 10-019054 A disclose damping elements integrated into a universal joint for use in a steering shaft. Shown are inner and outer damper parts with wave-shaped contours between which an elastomeric damping material is disposed.

GB 897 771 B discloses a damping element disposed in a motor driveshaft, comprising first and second damper parts, of which one or both have contours that deviate from the circular form and between which an elastomeric damping material is located.

It is the objective of the applicant to provide an advantageous steering column of the type described above, in which vibrations transmitted via the steering shaft are effectively and purposefully damped. In the steering column the damping element is integrated into the rearward steering shaft segment, with the inner and the outer damper part being rotatable about the longitudinal center axis of the rearward steering shaft segment.

Thus, if one follows the steering shaft, starting from its rearward end on which the steering wheel is secured, up to its front end at which it is installed on the steering gearing, the steering shaft comprises, first, a rearward steering shaft segment extending in a straight line and rotatable about a longitudinal center axis. The damping element is located in the proximity of the longitudinal extent of the rearward steering shaft segment. A universal joint then follows and, adjoining it, at least one further segment of the steering shaft extending in a straight line. Instead of a universal joint, a different joint, for example a homokinetic joint, can also be disposed in the steering drive train. When the term universal joint is used herein, this term is always intended as a synonym for a corresponding joint which can transmit the torques at different angulations of the steering drive train. However, primarily and preferably, the classical cardan joint, also known by the name universal joint, is meant.

Referred to the direction of the longitudinal center axis of the rearward steering shaft segment, the damping element is advantageously spaced at a distance from the rearward joint fork, connected to the rearward steering shaft segment, of the universal joint, wherein this distance corresponds, preferably corresponds at least, to the diameter, measured directly following the connection to the rearward joint fork, of the shaft part, leading away from the rearward joint fork, of the rearward steering shaft segment.

Through the disposition according to the invention advantageous integration into the steering column is enabled, wherein the entire installation space required for the steering column can be kept small. The extent of the steering shaft located at the steering wheel-side of the damping element is kept minimal such that a short residual length of the steering shaft is obtained over which vibrations transmitted over the steering shaft, for example also in the form of structure-borne sound, are transmitted undamped onto the steering wheel or structural members of the motor vehicle.

A feasible implementation provides for the steering column to comprise an electric power assistance unit. Such electric power assistance units serve for the augmentation or boosting of the steering force exerted by the driver and/or represent auxiliary power-operated steering angle superposition units. The damping element is here advantageously located between the rearward end of the rearward steering shaft segment and the electric power assistance unit. Thus, if, starting from its rearward end, the steering shaft is followed up to its front end, the rearward end is first adjoined by the straight rearward steering shaft segment. The damping element is disposed at a site of its longitudinal extent. Further removed from the rearward end of the steering shaft, the power assistance unit cooperates with the steering shaft, preferably always still in the rearward steering shaft segment. At its front end the rearward steering shaft segment is connected to the first universal joint which is followed by a further steering shaft segment. Vibrations transmitted from the power assistance unit onto the steering shaft are consequently damped by the damping element before they can be transmitted to the steering wheel.

To develop a connection that acts under form closure, with respect to the rotational direction about the longitudinal center axis of the first steering shaft segment, between the inner damper part and the outer damper part across the interspaced elastomeric damping material, it is advantageously provided that, viewed in cross section through the damping element, the inner damper part has an outer circumferential contour deviating from the circular form, that the outer damper part has an inner circumferential contour deviating from the circular form, and that the interspaced elastomeric damping material has an inner circumferential contour corresponding to the outer circumferential contour of the inner damper part and deviating from the circular form, and an outer circumferential contour corresponding to the inner circumferential contour of the outer damper part and deviating from the circular form.

In addition to the damping element, one or several further damping elements can be disposed in the steering shaft. Their disposition can herein be in the first steering shaft segment and/or in another steering shaft segment and/or in a universal joint connecting two steering shaft segments.

The rearward steering shaft segment is advantageously rotatably supported via at least one front pivot bearing located between the damping element and the universal joint. It is further preferred for the rearward steering shaft segment to be rotatably supported via at least one rearward pivot bearing located between the damping element and the rearward end of the rearward steering shaft segment. Herewith there can also be attained good coaxial orientation of the damping element.

The steering column can be at least adjustable in its length, wherein the rearward steering shaft segment comprises two shaft parts telescopable with respect to one another.

In all embodiments of the invention damping elements can advantageously be employed in which, viewed in cross section through the damping element, the inner circumferential contour of the outer damper part comprises several inner elevations, spaced apart from one another in the circumferential direction about the longitudinal center axis of the rearward steering shaft segment and projecting radially inwardly, between which are located inner indentations of the inner circumferential contour of the outer damper part, and the outer circumferential contour of the inner damper part comprises several outer elevations, spaced apart in the circumferential direction about the longitudinal center axis and projecting radially outwardly, between which outer indentations of the outer circumferential contour of the inner damper part are located, wherein the outer elevations of the outer circumferential contour of the inner damper part project into the inner indentations of the inner circumferential contour of the outer damper part. Of particular advantage is the development of a damper in which the angular range over which a particular outer elevation of the outer circumferential contour of the inner damper part extends in the circumferential direction about the longitudinal center axis is smaller than the particular angular range over which extends a particular outer indentation of the outer circumferential contour of the inner damper part in the circumferential direction about the longitudinal center axis.

A feasible development provides that, viewed in cross section through the damping element, the outer circumferential contour of the inner damper part comprises curved first segments which form the outer elevations, wherein the first segments have a first radius of curvature or the outer elevations formed by the first segments are inscribed in a first radius of curvature, and second segments, located between the first segments in the regions of outer indentations, which have a second radius of curvature greater than the first radius of curvature or which extend in straight lines. It is herein preferred for the second radius of curvature to be more than twice as large, preferably more than three times as large, as the first radius of curvature. When it was previously mentioned that the elevations formed by the first segments can be inscribed in a radius of curvature, the radius of the smallest circle is meant that can be arranged around the particular elevation.

The damper part can advantageously be developed in all embodiments of the invention such that the outer damper part has, viewed in cross section through the damping element, an outer circumferential contour deviating from the circular form, with which contour it engages with an inner circumferential contour, deviating, viewed in cross section through the damping element, from the circular form, of a sleeve-shaped segment of a first shaft part of the rearward steering shaft segment, under form closure with respect to the rotational direction about the longitudinal center axis. Through this sleeve-shaped closure an especially compact and vibration-damping element is formed. It is herein advantageous if the first shaft part sticks out from the damping element in the axial direction of the rearward steering shaft segment, i.e. the first shaft part projects over the damping element in the axial direction.

To facilitate the mounting, in some application cases it can be provided that the inner damper part has an inner circumferential contour, that, viewed in cross section, deviates from the circular form, with which it engages with an outer circumferential contour, with an, viewed in cross section, outer circumferential contour deviating from the circular form, of a segment of a second shaft part of the rearward steering shaft segment, under form closure with respect to the rotational direction about the longitudinal center axis. Here also can be provided that the second shaft part projects from the damping element in the axial direction of the rearward steering shaft segment.

The steering column can with advantage be implemented such that the second shaft part is connected non-rotatably with a third shaft part, wherein the third shaft part projects from the second shaft part in the axial direction of the rearward steering shaft segment.

The terms “front” and “rearward”, when used in this document in connection with the steering column or steering shaft, are to be understood with reference to the forward driving direction or with reference to the distance from the front of the motor vehicle.

The terms “inner” and “outer”, when used in this document in connection with the rearward steering shaft segment or with the damping element, are referring to the radial position relative to the longitudinal center axis of the rearward steering shaft segment. A part located further inwardly thus is located at a shorter distance from the longitudinal center axis than a part located further outwardly.

### BRIEF DESCRIPTION OF THE DRAWINGS

Further advantages and details of the invention will be explained in the following in conjunction with the enclosed drawing. In the drawing depict:

FIG. 1 an oblique view of a portion adjoining the rearward end of the steering shaft, with the parts bearing and supporting the steering shaft in a corresponding oblique view;

FIG. 2 a side view;

FIG. 3 a view from below;

FIG. 4 a longitudinal center sectional view through the parts, located in the proximity of the rearward steering shaft segment, along a section line AA of FIG. 3;

FIG. 5 an enlarged depiction of the steering shaft in the proximity of the damping element in a longitudinal center sectional view according to FIG. 4;

FIG. 6 a sectional view along line BB of FIG. 4;

FIG. 7 a portion of a steering shaft adjoining the rearward end, with the parts bearing and supporting the steering shaft according to a second embodiment, in side view;

FIG. 8 the parts of FIG. 7 in oblique view;

FIG. 9 the second embodiment in the proximity of the rearward steering shaft segment depicted in longitudinal center sectional view;

FIG. 10 an enlarged detail from FIG. 9;

FIG. 11 an oblique view of a portion of the apparatus according to the second embodiment;

FIG. 12 an exploded view of parts of the steering shaft;

FIG. 13 a longitudinal center sectional view through the parts according to FIG. 12;

FIG. 14 an oblique view of a minimally modified further embodiment;

FIGS. 15 and 16 depictions analogous to FIG. 12 and FIG. 13 of a further, modified embodiment;

FIG. 17 a depiction analogous to FIG. 14 of yet a further, modified embodiment;

FIG. 18 a depiction analogous to FIG. 2 of yet a further, modified embodiment.

### DETAILED DESCRIPTION

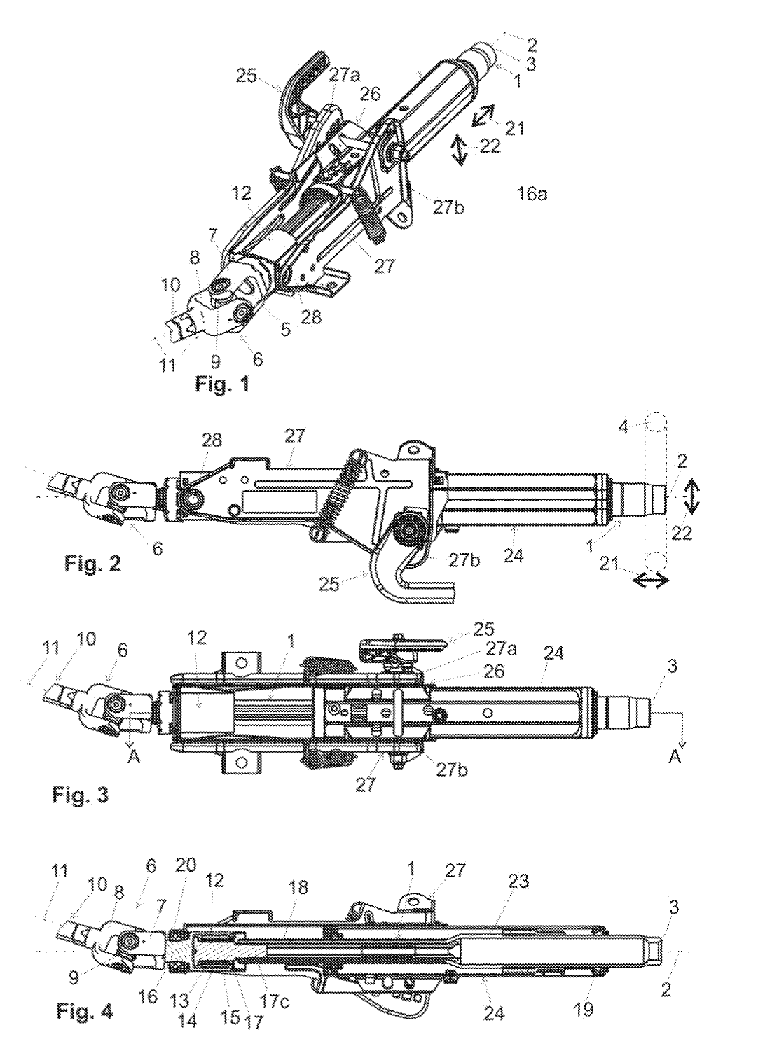

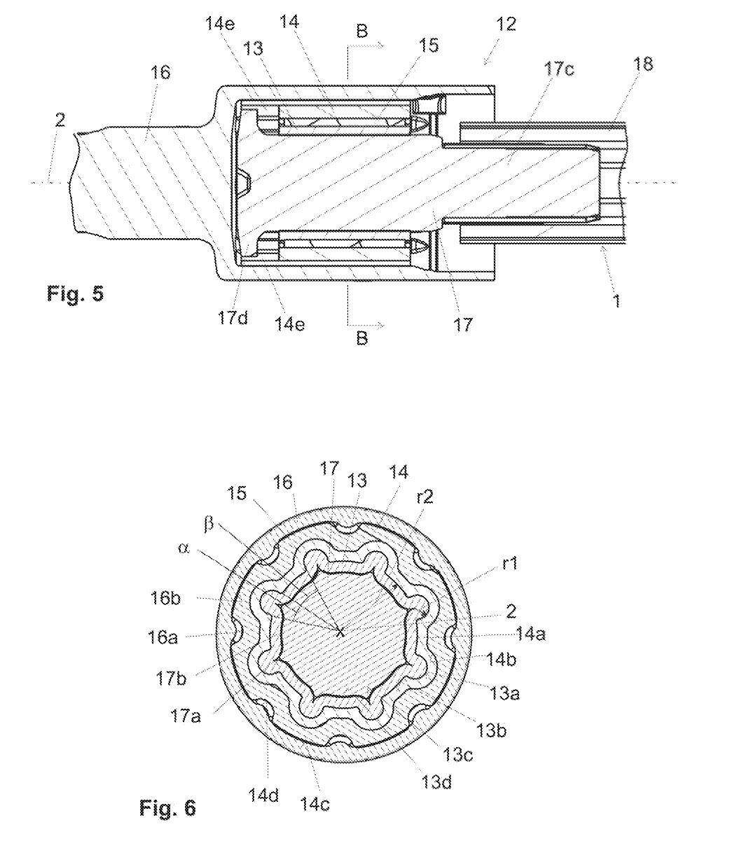

A first embodiment example of the invention is depicted in FIG. 1 to FIG. 6.

The steering column comprises a steering shaft with a rearward steering shaft segment 1 that extends in a straight line and is rotatable about a longitudinal center axis 2. On the rearward end 3 of the rearward steering shaft segment 1 can be mounted a steering wheel 4 only schematically indicated by dashed lines.

The rearward steering shaft segment 1 extends from a rearward end 3 in a straight line up to a front end 5 in the proximity of which the rearward steering shaft segment 1 is connected with a universal joint 6 of the steering shaft. The universal joint 6 comprises a rearward joint fork 7, a front joint fork 8 and a joint cross 9 connecting the front and the rearward joint fork in an articulated joint. The rearward joint fork 7 is fixed on the rearward steering shaft segment 1. The front joint fork 8 is fixed on a further steering shaft segment 10. This segment, again, extends in a straight line along a longitudinal center axis 11 which forms a non-zero angle with the longitudinal center axis 2 of the rearward steering shaft segment 1, wherein the deviation from the parallel position of these two longitudinal center axes 2, 11 is in particular more than 20°.

The further steering shaft segment 10 can be directly connected with a steering gearing (not shown) or it can be connected via a further universal joint with a further, straight steering shaft segment which, in turn, is connected with the steering gearing. In principle, the interposition of still further steering shaft segments is feasible.

Into the rearward steering shaft segment is integrated a damping element 12. The damping element 12 comprises an inner damper part 13 which, viewed in cross section (cf. FIG. 6), has an outer circumferential contour deviating from the circular form and an outer damper part 14 which, viewed in cross section, has an inner circumferential contour deviating from the circular form. The outer damper part 14 annularly encompasses the inner damper part 13, i.e. the outer damper part 14 has the form of a sleeve. The inner and the outer damper part 13, 14 are coaxial with respect to one another and coaxial with the rearward steering shaft segment 1, i.e. the inner and the outer damper part 13, 14 are rotatable about the longitudinal center axis 2 of the rearward steering shaft segment.

In the radial interspace between the inner and the outer damper part 13, 14 is located an elastomeric damping material 15 which realizes a sleeve form and has inner and outer circumferential contours deviating from the circular form when viewed in cross section.

Via the elastomeric damping material the inner and the outer damper part 13, 14 are in engagement under form closure referred to the rotation about the longitudinal center axis 2. The inner and the outer damper part 13, 14 are thus, with respect to rotation about the longitudinal center axis 2, connected non-rotatably with one another (apart from the elasticities effected by the elastomeric damping material). The inner and the outer damper part 13, 14, further, are each in non-rotatable connection with a shaft part of the rearward steering shaft segment 1 with respect to rotation about the longitudinal center axis 2.

The cross section through the damping element 12 or through a portion of the damping element 12 or a cross section through the rearward steering shaft segment 1 or a portion of the rearward steering shaft segment 1 in the discourse of this document is always meant to indicate a cross section at right angles to the longitudinal center axis 2 of the rearward steering shaft segment 1 or of the damping element 12 (according to FIG. 6).

Viewed in cross section through the damping element 12, the inner circumferential contour of the outer damper part 14 (this contour corresponds to the cross section through the inner surface of the outer damper part 14) comprises several inner elevations 14a, projecting radially inwardly (thus in the direction toward the longitudinal center axis 2), between which inner indentations 14b of the inner circumferential contour of the outer damper part 14 are located. Inner elevations 14a sequentially following on one another in the circumferential direction (=rotational direction) about the longitudinal center axis 2 are each spaced apart by an interspaced inner indentation 14b. The transition between each inner elevation 14a and inner indentation 14b adjoining thereon can be estimated to be where the inner circumferential contour of the outer damper part 14 crosses that radial site which corresponds to the midpoint between the radially innermost point of the inner elevation 14a and the radially outermost point of the inner indentation 14b.

Viewed in cross section through the damping element 12, the outer circumferential contour of the inner damper part 13 (this contour corresponds to the cross section through the outer surface of the inner damper part 13) comprises several radially outwardly projecting (thus in the direction directed away from the longitudinal center axis 2) outer elevations 13a, between which outer indentations 13b of the outer circumferential contour of the inner damper part 13 are located. Outer elevations 13a, sequentially following on one another in the circumferential direction (=rotational direction) about the longitudinal center axis 2, are each spaced apart from one another by an interspaced outer indentation 13b. The transition between each outer elevation 13a and the outer indentation 13b adjoining thereon can be estimated to be where the outer circumferential contour of the inner damper part 13 crosses that radial site that corresponds to the midpoint between the radially outermost point of the outer elevation 13a and the radially innermost point of the outer indentation 13b.

The outer elevations 13a of the outer circumferential contour of the inner damper part 13 project into the inner indentations 14b of the inner circumferential contour of the outer damper part 14, i.e. there is radial overlap.

In the radial interspace between the inner damper part 13 and the outer damper part 14 is disposed an elastomeric damping material 15. This interspace is preferably filled completely by the elastomeric damping material 15. The elastomeric damping material 15 is in particular a rubber elastomer. Other elastomeric materials, for example also thermoplastic elastomers, could also be provided.

The elastomeric damping material 15 engages into the inner indentations 14b of the outer damper part 14 and into the outer indentations 13b of the inner damper part 13 and is therewith connected under form closure with the outer damper part 14 and the inner damper part 13 from the perspective of the rotational direction about the longitudinal center axis 2.

The damping material 15 is preferably connected under material closure with the inner surface of the outer damper part 14 as well as also with the outer surface of the inner damper part 13. An adhesive connection is also conceivable and feasible. It can, for example, also be vulcanized onto both damper parts 13, 14. Adhesion to both damper parts 13, 14 or vulcanization onto one of the damper parts 13, 14 and adhesion to the other damper part 13, 14 is, for example, also feasible.

Viewed in cross section through the damping element 12, the outer circumferential contour of the inner damper part 13 includes curved first segments which form the outer elevations 13a and which have a first radius of curvature r1 or are inscribed in a first radius of curvature r1. In the latter case this is the radius of the smallest circle which can be arranged around the particular elevation 13a. Between these first segments are located second segments of the outer circumferential contour of the inner damper part 13, which are thus located in the proximities of the outer indentations 13b. These second segments have a second radius of curvature r2 that is greater, preferably more than twice as great, in particular preferred more than three times as great as the first radius of curvature r1. The second segments advantageously are curved in the form of a circular arc about the longitudinal center axis 2, wherein the second radius of curvature r2 thus corresponds to the radius of a circle, extending about the longitudinal center axis 2, on which are, at least segment-wise, located the bases of the outer indentations 13b. This is the smallest circumscribed circle on which at least one point of the outer circumferential contour of the inner damper part 13 is located. The second radius of curvature r2 could also, compared to the radius of such smallest circumscribed circle, be for example greater or smaller by up to 30%.

The bases of the outer indentations 13b in the depicted embodiment example thus have an outwardly convexly curved form. A straight course or, viewed from the outer side, a concavely curved form of the bases of the indentations 13b or of said second segments is conceivable and feasible in a modified embodiment.

If, as stated, a smallest circumscribed circle of the inner damper part 13 is defined as that circle that extends through the radially innermost points of the outer indentations 13b, and a greatest circumscribed circle is defined as that circle that extends through the radially outermost points of the outer elevations 13a, then the radius of the greatest circumscribed circle is preferably greater by 10% to 30% than the radius of the smallest circumscribed circle.

The inner circumferential contour of the outer damper part 14 in the proximity of the inner indentations 14b preferably has a circular arc-shaped curvature which is concentric with respect to the circular arc-shaped curvature of each of the particular said first segments of the outer circumferential contour of the inner damper part 13. The radius of this circular arc-shaped curvature of the inner circumferential contour in the proximity of the inner indentation 14b is herein greater by the wall thickness of the elastomeric damping material 15 than the radius of curvature r1.

In the embodiment example the inner damper part 13 is formed by a sleeve. The first radius of curvature r1 in that case is preferably the 0.8- to 1.2-fold of the value of the wall thickness of this sleeve measured in the proximity of one of the outer indentations 13b. The outer elevations 13a are thus formed by at least largely, advantageously at least partially completely, folded-together segments of the sleeve wall. In this way a stable realization can be attained.

The angular range α over which a particular outer elevation 13a extends in the circumferential direction (=rotational direction) about the longitudinal center axis 2 is smaller than the particular angular range β over which extends a particular outer indentation 13b in the circumferential direction about the longitudinal center axis 2.

The angular range β is preferably greater by 25% to 50%, especially preferred by 30% to 45%, than the angular range α.

The outer elevations 13a and outer indentations 13b developed on the outer surface of the inner damper part 13 and the inner elevations 14a and inner indentations 14b developed on the inner surface of the outer damper part 14 extend in the axial direction, thus parallel to the longitudinal center axis 2.

Advantageously at least four outer elevations 13a and at least four outer indentations 13b are provided around the circumference of the inner damper part 13, wherein a value of eight each is especially preferred. The outer damper part 14 comprises a corresponding number of inner elevations 14a and inner indentations 14b.

The outer damper part 14 is connected non-rotatably with a first shaft part 16 of the rearward steering shaft segment 1. This shaft part 16 projects from the damping element 12 in the axial direction of the rearward steering shaft segment 1, thus continues from the damping element 12 in a direction along the longitudinal center axis 2. For the non-rotatable connection the outer damper part 14 has, viewed in cross section through the damping element 12, an outer circumferential contour, deviating from the circular form, which is formed by outer elevations 14c and interposed outer indentations 14d, and the first shaft part 16 comprises a sleeve-shaped segment with, viewed in cross section, an inner circumferential contour, deviating from the circular form, which is formed by inner elevations 16a and interposed inner indentations 16b. Through the inner elevations 16a in engagement with the outer indentations 14d and the inner indentations 16b in engagement with the outer elevations 14c a form closure is developed between the outer damper part 14 and the first shaft part 16 with respect to the rotational direction about the longitudinal center axis 2.

The outer indentations 14d are each located in the angular range (referred to the circumferential direction about the longitudinal center axis 2) of one of the inner elevations 14a, and the outer elevations 14c encompass each the angular range (referred to the circumferential direction about the longitudinal center axis 2) of one of the inner indentations 14b.

In the embodiment example a radial gap is provided between an inner elevation 16a of the first shaft part 16 and the outer indentation 14d of the outer damper part 14.

The top sides of the outer elevations 14c and the bases of the inner indentations 16b extend in a curve in the form of a cylinder jacket about the longitudinal center axis 2. In these regions the shaft part 16 is pressed onto the outer damper part 14 such that a force or press fit is developed.

In the embodiment example the sleeve-shaped segment of the first shaft part 16, in which this part encompasses the outer damper part 14, is adjoined by a solid segment of the first shaft part 16. It would also be conceivable and feasible to implement the first shaft part 16 overall in the shape of a sleeve.

The inner damper part 13 developed in the shape of a sleeve in the embodiment example is connected non-rotatably with a second shaft part 17. The inner damper part 13 has for this purpose, viewed in cross section, an inner circumferential contour deviating from the circular form. This contour is formed by inner indentations 13c between which inner elevations 13d are located. The inner indentations 13c are each in an angular range (referred to the circumferential direction about the longitudinal center axis 2) of one of the outer elevations 13a and inner elevations 13d encompass each the angular range (referred to the circumferential direction about the longitudinal center axis 2) of one of the outer indentations 13b. The second shaft part 17, viewed in cross section through the damping element 12, has an outer circumferential contour, deviating from the circular form, which is formed by outer elevations 17a between which are located outer indentations 17b. The outer elevations 17a of the second shaft part are in engagement with the inner indentations 13c of the inner damper part 13 and the outer indentations 17b of the second shaft part are in engagement with the inner elevations 13d of the inner damper part 13, wherein through these engagements form closures, with respect to the rotational direction about the longitudinal center axis 2, are developed in each case.

The bases of the outer indentations 17b of the second shaft part 17 and the top sides of the inner elevations 13d of the inner damper part 13 extend in a curve in the shape of a cylinder jacket about the longitudinal center axis 2. The inner damper part 13 in these regions is pressed onto the second shaft part 17 such that a press fit is developed.

The second shaft part 17 projects from the damping element 12 in the axial direction of the rearward steering shaft segment 1 and specifically in the opposite direction as the first shaft part 16. The portion of the second shaft part 17 projecting from the damping element 12 herein forms a connection peg 17c via which the second shaft part is connected non-rotatably with a third shaft part 18 which projects from the second shaft part in the axial direction of the rearward steering shaft segment (in the direction remote from the damping element 12).

On the side on which the first shaft part 16 leads away from the damping element 12, the second shaft part 17 also protrudes axially over the inner and the outer damper part 13, 14. The second shaft part comprises in this region a radially outward projecting collar 17d. Hereby a safety is formed against the second shaft part 17 being axially pulled out of the inner damper part 13. The collar 17d can be developed, for example, as an annular collar. It is conceivable and feasible to provide the collar 17d with a circumferential contour, deviating from a circular form, with contact faces which, under very large twisting moments between the first shaft part 16 and the second shaft part 17, or the third shaft part 18, is brought into contact with contact segments 14e of the outer damper part 14 or directly, not depicted here, with contact segments of the first shaft part 16. Excessive strain of the damping material 15 can be avoided in this way.

The second shaft part 17 can be produced simply using a sintering process or a forging method. Depending on the implementation, production of the second shaft part using an extrusion process is also conceivable and feasible.

The damping element 12 is thus located in the region of the longitudinal extent of the rearward steering shaft segment 1 and coaxially therewith. On both sides of the damping element 12, referred to the axial direction of the rearward steering shaft segment 1, are located portions of the rearward steering shaft segment 1.

The rearward steering shaft segment 1 is rotatably supported via at least one rearward pivot bearing 19 located in the axial region between the damping element 12 and the rearward end 3 of the rearward steering shaft segment 1. Further, the rearward steering shaft segment 1 is rotatably supported via a front pivot bearing 20 which is located in the axial region between the damping element 12 and the universal joint 6.

The steering column depicted in this embodiment example is adjustable in the displacement directions 21 and 22. The displacement direction 21 is parallel to the longitudinal center axis 2 and enables a length adjustment. For this purpose the rearward steering shaft segment comprises two subpieces that are telescopable with respect to one another. One of these two telescopable subpieces is formed by the previously described third shaft part 18. The other of these telescopable subpieces is formed by a fourth shaft part 23 which extends up to the rearward end 3 of the rearward steering shaft segment 1 and which is rotatably supported via the rearward pivot bearing 19 with respect to a jacket unit 24 of the steering column. In the open state of a securement device 25 the jacket unit 4 is displaceable in the displacement direction 21 with respect to a swivel unit 26. In the closed state of the securement device the jacket unit 24 is clamped robustly together with the swivel unit 26. To adjust the steering column in the displacement direction 22, which represents a height or inclination adjustment of the steering column, the swivel unit 26, in the open state of the securement device 25, is swivellable with respect to a mounting bracket unit 27 about a swivel axis 28 located horizontally and at right angles to the longitudinal center axis 2. In the closed state of the securement device 25 the swivel unit 26 is clamped robustly between side jaws 27a, 27b of the mounting bracket unit.

The mounting bracket unit 27 is mounted on the body of the motor vehicle.

Fixing the set position in the closed state of the securement device 25 can take place using elements cooperating under friction closure and/or form closure, as is known. To open and close the securement device, an actuation lever is used. At least one electrically operated driving means can, instead, also be provided.

The rearward steering shaft segment 1, in particular the first shaft part 16, is supported by the front pivot bearing 20 rotatably with respect to the swivel unit 26.

The damping element 12 is located in the embodiment example in the region of the front end of the parts of the steering column supporting and bearing the rearward steering shaft segment 1.

With respect to axial deflections between the inner and the outer damper part 13, 14, the damping element 12 is much more pliant than with respect to deflections in the rotational direction about the longitudinal center axis 2, preferably more than three times more elastic in the axial direction than in the rotational direction.

Through the engagement of the outer elevations 13a of the inner damper part 13 into the inner indentations 14b of the outer damper part 14, the elastomeric damping material 15 interspaced in these regions is at least substantially compressed (=the effective force acts at least substantially parallel to the surface normal onto the damping material 15) under loading in the rotational direction, thus is at least not substantially strained with shearing forces. The elasticity for a compression, however, is substantially less than under shearing loading. In contrast, with an axial deflection between the inner and the outer damper part 13, 14, at least substantially a shearing loading of the damping material 15 occurs.

In the embodiment example the inner damper part 13 is disposed at the drive end and is driven by the shaft part 17 connected at the drive end with the damping element. The outer damper part 14 is disposed at the driven end and drives the shaft part 16 connected thereto. The disposition of the outer damper part 14 at the drive end and the disposition of the inner damper part 13 at the driven end is also feasible.

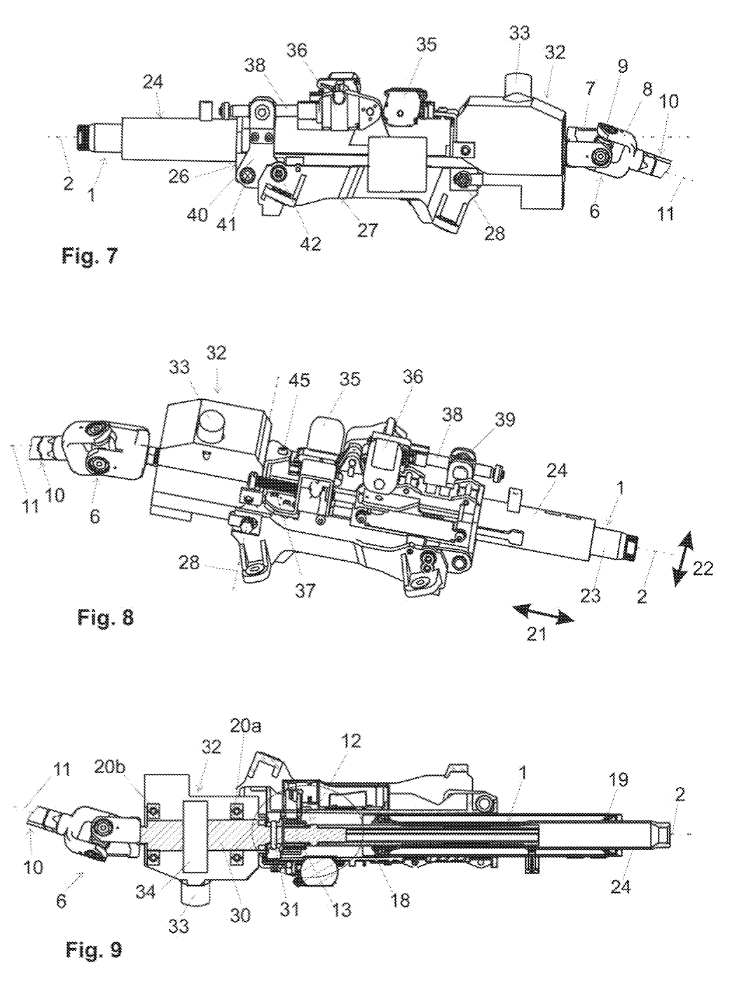

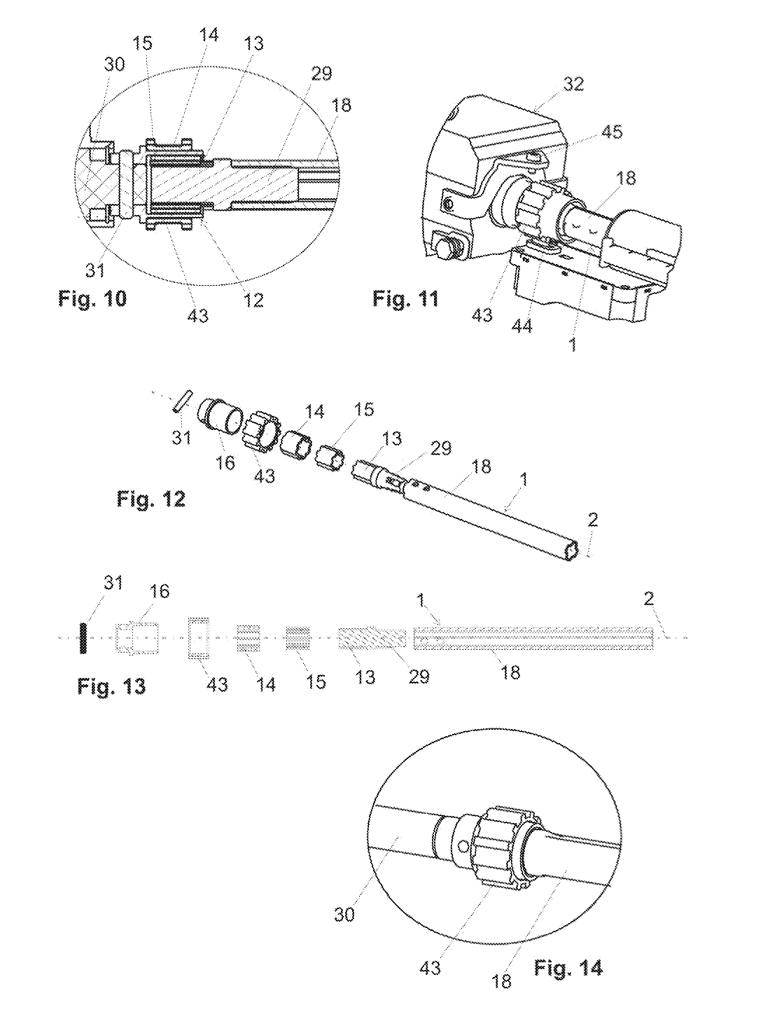

A second embodiment example of the invention is depicted in FIG. 7 to FIG. 13. Apart from the differences explained in the following, it corresponds to the previously described embodiment example. Analogous parts are provided with the same reference numbers.

In this embodiment example the inner damper part 13 is developed unitarily with a connection peg 29 projecting axially from the damping element 12, which peg is non-rotatably connected with the third shaft part 18. This structural part comprising the inner damper part 13 and the connection peg 29 thus cooperates via a segment of its axial extent via the damping material 15 with the outer damper part 14 and forms in this axial segment of its extent the inner damper part 13. This inner damper part 13 is here developed as a solid part. However, a sleeve-shaped development of the inner damper part 13 and/or of the connection peg 29 would also be feasible. The outer surface of the inner damper part 13 or, viewed in the cross section, the outer circumferential contour of the inner damper part 13, corresponds in terms of form to the corresponding description of the inner damper part 13 of the first embodiment example.

The second shaft part 17 of the first embodiment example consequently is omitted in this second embodiment example.

The first shaft part 16 in that axial region in which it is in engagement with the outer damper part 14 corresponds to the first shaft part 16 of the first embodiment example. In this embodiment example, however, the first shaft part 16 is overall developed in the shape of a sleeve and connected with a further shaft part 30 via a pinned fitting using a joiner pin 31.

For the remainder, the damping element 12 is developed identically to the previously described first embodiment example.

The steering column comprises here an electric power assistance unit 32 shown only highly schematically. The shaft part 30 is a part of this electric power assistance unit 32. The electric power assistance unit 32 comprises an electromotor 33 and gearing members 34 via which the electromotor 33 is in connection with the rearward steering shaft segment 1. For example, by the electric power assistance unit an auxiliary force can be introduced into the steering shaft by which a steering motion of the driver is augmented or boosted. By the electromotor 33 an auxiliary power can also be exerted in order, for example, to carry out a transmission of the steering angle set by the driver or to carry out a steering motion independent of the driver.

Such electric power assistance units are known in several implementations.

The electric power assistance units 32 can be disposed in the rearward steering shaft segment between the damping element 12 and the universal joint 6.

In the region of the electric power assistance unit 32 front pivot bearings 20a, 20b are disposed by which a bearing support of the rearward steering shaft segment 1 takes place, here in the proximity of the shaft part 30.

The steering column according to this second embodiment of the invention is again adjustable in the displacement directions 21, 22, wherein here the adjustment takes place through electric driving means 35, 36. The electric driving means 35 is an electromotor by which a spindle nut 39 is rotated which is disposed on a threaded spindle 37. By turning the threaded nut a length adjustment in the displacement direction 21 takes place in which the jacket unit 24 rotatably bearing supporting the fourth shaft part 23 is shifted with respect to the swivel unit 26 in the displacement direction 21. For this purpose the electric driving means 35 is, referred to the displacement direction 21, nonshiftably connected with the jacket unit 24 and the threaded spindle 37 with the swivel unit 26.

The swivel unit 26 is supported swivellably about the swivel axis 28 with respect to the mounting bracket unit 27 securable on the body of the motor vehicle. For the adjustment in the displacement direction 22 serves the electric driving means 36. This means is developed in the form of an electromotor which turns a threaded spindle 38 about its axis. On the threaded spindle 38 is disposed a spindle nut 39 which is articulated with a setting lever 40. The setting lever 40 is supported on the swivel unit 26 such that it is swivellable about the swivel axis 41 and on the mounting bracket unit 27 about the swivel axis 42, wherein the swivel axes 41, 42 are parallel to the swivel axis 28. During the swivelling of the setting lever 40 about the swivel axis 42 the swivel unit 26 is swivelled about the swivel axis 28. The swivel axis 28 can herein become minimally shifted with respect to the mounting bracket unit 27 in the direction of the longitudinal center axis 2 (through the disposition of a bolt forming this swivel axis in elongated holes of the mounting bracket unit 27).

In a modification of the second embodiment the adjustment in the displacement directions 21, 22 could also take place manually analogously to the manner described in the first embodiment example.

In this second embodiment example a detent starwheel 43 is disposed on the first shaft part 16.

The detent starwheel 43 is located in the proximity of the (referred to the longitudinal center axis 2) axial extent of the elastic damping material 15. Stated differently, the detent starwheel 43 is disposed in an axial region of the rearward steering shaft segment 1, in which is also located the elastic damping material 15.

Through the detent starwheel 43 and a pawl element that can be brought into engagement therewith, an antitheft immobilizer can be realized. Through the appropriate layout of the press association between the detent starwheel 43 and the first shaft part 16 can be realized in simple manner a desired torsional strength for the detent starwheel 43, for example of 200 Nm, that, upon being exceeded, enables the detent starwheel 43 to slip through with respect to the first shaft part 16.

The detent starwheel 43 can also be omitted in the second embodiment or such a detent starwheel could also be provided in the first embodiment.

Through a detachable connection of the connection peg 29 with the third shaft part 18 and a detachable implementation of the pinned fitting with the joiner pin 31, a simple dismantlement capability of the damping element 12 can be provided. The power assistance unit 32 can also be connected via at least one bolt connection 45 with the swivel unit 26 such that maintenance work is enabled in simple manner by disconnecting the steering shaft. The bolt connections can be acoustically decoupled either via special intermediate pieces and/or via rubber interlayers (not shown).

FIG. 14 shows a minimal modification of the second embodiment without a power assistance unit.

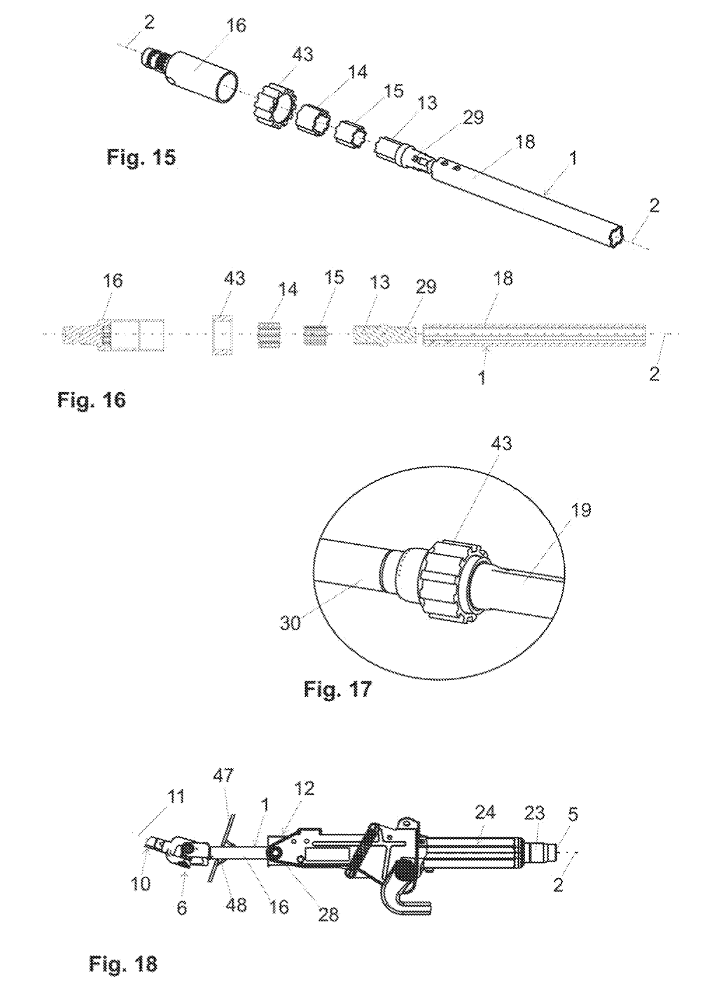

FIG. 15 shows a depiction corresponding to FIG. 12 and FIG. 13 in which the development is modified to the effect that the first shaft part 16, instead of through a pinned fitting, is connected through a pressed-in connection peg with a further part of the rearward steering shaft segment 1 or with the rearward joint fork 7 of the universal joint 6 through a press fitting. FIG. 17 shows the modification compared to FIG. 14 to the effect that, instead of the pinned fitting, such a press fitting with a further shaft part is provided.

FIG. 18 shows a modification of the first embodiment, wherein the first shaft part 16, compared to the first embodiment example is longer and guided through a firewall (=“dash board”) which separates the passenger compartment from the engine compartment. In the proximity of this guide-through a sealing is implemented of the first shaft part 16 with respect to the firewall 47. For this purpose a sealing collar 48 is depicted which can also be developed as a bearing for the rearward steering shaft segment 1.

A steering column according to the invention could also be developed such that it is only adjustable in the displacement direction 21 or only in the displacement direction 22 or such that it is nonadjustable.

To the extent applicable, all features shown in the individual embodiments are freely combinable with each other without leaving the scope of the invention.

### LEGEND TO THE REFERENCE NUMBERS

1. Rearward steering shaft segment
2 Longitudinal center axis
3 Rearward end
4 Steering wheel
5 Front end
6 Universal joint
7 Rearward joint fork
8 Front joint fork
9 Joint cross
10 Further steering shaft segment
11 Longitudinal center axis
12 Damping element
16 Inner damper part
13a Outer elevation
13b Outer indentation
13c Inner indentation
13d Inner elevation
14 Outer damper part
14a Inner elevation
14b Inner indentation
14c Outer elevation
14d Outer indentation
14e Contact segment
15 Damping material
16 First shaft part
16a Inner elevation
16b Inner indentation
17 Second shaft part
17a Outer elevation
17b Outer indentation
17c Connection peg
17d Collar
18 Third shaft part
19 Rearward pivot bearing
20 Front pivot bearing
20a Front pivot bearing
20b Front pivot bearing
21 Displacement direction
22 Displacement direction
23 Fourth shaft part
24 Jacket unit
25 Securement device
26 Swivel unit
27 Mounting bracket unit
27a Side jaws
27b Side jaws
28 Swivel axis
29 Connection peg
Shaft part
31 Joiner pin
32 Electric power assistance unit
33 Electromotor
34 Gearing member
35 Electric driving means
36 Electric driving means
37 Threaded spindle
38 Threaded spindle
39 Spindle nut
40 Setting lever
41 Swivel axis
42 Swivel axis
43 Detent starwheel
44 Pawl
45 Bolt connection
47 Firewall
48 Sealing collar

1. A steering column for a motor vehicle, with a steering shaft comprising a rearward steering shaft segment, that extends in a straight line and is rotatable about a longitudinal center axis and to which at a rearward end a steering wheel is mountable, and at least one further steering shaft segment which is connected with the rearward steering shaft segment via a universal joint that comprises a rearward joint fork, a front joint fork and a joint cross connecting the rearward joint fork and the front joint fork, wherein for damping vibrations transmitted via the steering shaft a damping element is provided comprising an inner damper part which, viewed in cross section through the damping element, has an outer circumferential contour deviating from the circular form, an outer damper part, encompassing the inner damper part, the outer damper part having an inner circumferential contour deviating, viewed in cross section through the damping element, from the circular form, and an elastomeric damping material disposed between the inner damper part and the outer damper part, wherein the damping element is integrated into the rearward steering shaft segment, and wherein the inner damper part and the outer damper part are rotatable about the longitudinal center axis of the rearward steering shaft segment.

2. The steering column as in claim 1, wherein the outer damper part has an outer circumferential contour, deviating, viewed in cross section through the damping element, from the circular form, with which it is in engagement under form closure, with respect to the rotational direction about the longitudinal center axis, with an inner circumferential contour, deviating, viewed in cross section through the damping element, from the circular form, of a sleeve-shaped segment of a first shaft part of the rearward steering shaft segment.

3. The steering column as in claim 2, further comprising a detent starwheel of an anti-theft immobilizer, said detent starwheel being disposed on the first shaft part.

4. The steering column as in claim 3, wherein the detent starwheel is located in an axial region of the rearward steering shaft segment in which is also disposed the elastic damping material.

5. The steering column as in claim 1, wherein in the direction of the longitudinal center axis of the rearward steering shaft segment, the damping element is at a spacing from the rearward joint fork of the universal joint, and wherein the rearward joint fork is connected to the rearward steering shaft segment.

6. The steering column as in claim 5, wherein the spacing from the rearward joint fork is at least equal to the diameter of the shaft part, leading away from the rearward joint fork, of the rearward steering shaft segment.

7. The steering column as in claim 1, wherein the rearward steering shaft segment is rotatably supported via at least one front pivot bearing which is located between the damping element and the universal joint.

8. The steering column as in claim 1, wherein the rearward steering shaft segment is rotatably supported via at least a rearward pivot bearing which is located between the damping element and the rearward end of the rearward steering shaft segment.

9. The steering column as in claim 1, wherein the steering column comprises an electric power assistance unit, wherein the damping element is disposed between the rearward end of the rearward steering shaft segment and the electric power assistance unit.

10. The steering column as in claim 1, wherein the steering column is at least adjustable in its length, wherein the rearward steering shaft segment comprises two shaft parts that are telescopable with respect to one another.

11. The steering column as in claim 1, wherein, viewed in cross section through the damping element, the inner circumferential contour of the outer damper part comprises several inner elevations, spaced apart in the circumferential direction about the longitudinal center axis of the rearward steering shaft segment and radially projecting inwardly, between which inner indentations of the inner circumferential contour of the outer damper part are located, and the outer circumferential contour of the inner damper part comprises several outer elevations spaced apart from one another in the circumferential direction about the longitudinal center axis and projecting radially outwardly, between which outer indentations of the outer circumferential contour of the inner damper part are located, wherein the outer elevations of the outer circumferential contour of the inner damper part project into the inner indentations of the inner circumferential contour of the outer damper part.

12. The steering column as in claim 11, wherein, viewed in cross section through the damping element, the outer circumferential contour of the inner damper part comprises curved first segments, which form the outer elevations wherein the first segments have a first radius of curvature or the outer elevations formed by the first segments are inscribed in the first radius of curvature, and second segments which are located between the first segments in the regions of the outer indentations and which have a second radius of curvature greater than the first radius of curvature or extend in a straight line.

13. The steering column as in claim 2, wherein the first shaft part projects from the damping element in the axial direction of the rearward steering shaft segment.

14. The steering column as in claim 1, wherein the inner damper part, viewed in cross section through the damping element, has an inner circumferential contour, deviating from the circular form, with which it is in engagement with an outer circumferential contour, deviating, viewed in cross section through the damping element, from the circular form, of a segment of a second shaft part of the rearward steering shaft segment under form closure with respect to the rotational direction about the longitudinal center axis, wherein the second shaft part projects from the damping element in the axial direction of the rearward steering shaft segment.

15. The steering column as in claim 14, wherein the second shaft part is connected non-rotatably with a third shaft part, wherein the third shaft part projects from the second shaft part in the axial direction of the rearward steering shaft segment.
